(19) United States
(12) Patent Application Publication
(10) Pub. No.: US 2018/0189516 A1
(43) Pub. Date: Jul. 5, 2018

(54) METHODS AND APPARATUS TO PROVIDE PRIVACY FROM DRONES USING SHORT TERM MEMORY LOSS

(71) Applicant: Intel Corporation, Santa Clara, CA (US)

(72) Inventors: DAVID W. BROWNING, Beaverton, OR (US); KEVIN J. DORAN, North Plains, OR (US); KIRK W. SKEBA, Fremont, CA (US); MUHAMMAD ABOZAED, Haifa (IL); ANAND S. KONANUR, Sunnyvale, CA (US); ANURADHA SRINIVASAN, Bangalore (IN)

(21) Appl. No.: 15/433,723

(22) Filed: Feb. 15, 2017

(30) Foreign Application Priority Data
Jan. 3, 2017 (IN) 201741000165

(51) Int. Cl. G06F 21/62; B64C 39/02; G08G 5/00

(52) U.S. Cl. CPC G06F 21/6245; B64C 39/024; B64C 2201/127; G06F 2221/2143; G08G 5/006

(57) ABSTRACT

Methods and apparatus for preserving privacy from a drone are disclosed herein. An example drone includes a privacy mode controller to, when the drone is within a restricted zone, flag data gathered by the drone in the restricted zone; and a private data deleter to, when the drone exits the restricted zone, delete the flagged data.

### FIELD OF THE DISCLOSURE

This disclosure relates generally to drones, more particularly, to methods and apparatus to provide privacy from drones using short term memory loss.

### BACKGROUND

Unmanned aerial vehicles, such as drones, are aircrafts that receive or generate navigational paths to travel from a first location to a second location without a pilot on board. Drones have sophisticated on-board systems that allow the drones to travel autonomously and/or via remote control. Recently, drones have increased in popularity expanding from military application to commercial, recreational, and other applications.

### BRIEF DESCRIPTION OF THE DRAWINGS

FIG. 1 illustrates an example drone navigating through an environment including restricted zones.

FIG. 2 is a block diagram of an example privacy controller of FIG. 1.

FIG. 3 is a flowchart representative of example machine readable instructions that may be executed to implement the example privacy controller of FIGS. 1 and/or 2 to enable privacy mode during navigation of the example drone through the example environment of FIG. 1 during autonomous navigation.

FIG. 4 is a flowchart representative of example machine readable instructions that may be executed to implement the example privacy controller of FIGS. 1 and/or 2 to enable privacy mode during navigation of the example drone through the example environment of FIG. 1 during user controlled and/or semi-autonomous navigation.

FIG. 5 is a block diagram of an example processor platform that may be utilized to execute the example instructions of FIGS. 3-4 to implement the example privacy controller of FIG. 1 and/or 2.

The figures are not to scale. Wherever possible, the same reference numbers will be used throughout the drawing(s) and accompanying written description to refer to the same or like parts.

### DETAILED DESCRIPTION

Unmanned aerial vehicles, such as drones, have recently increased in popularity with the decrease in the price of such aerial vehicles. Although drones were originally designed for military applications, the application of drones has expanded to surveillance, photography, agriculture, racing, delivery, and various other applications. Drones may be controlled by a user using a remote control, by instructions from a base station, and/or autonomously via on-board computers.

Drones are equipped with sensors (e.g., imaging sensors, audio sensors, radio detecting and ranging (RADAR) sensors, light detecting and ranging (LIDAR) sensors, sound detecting and ranging (SONAR) sensors, etc.) that capture image and/or audio data to help the drones navigate around obstacles during autonomous and/or semi-autonomous flight. As used herein, image data may include, but is not limited to, photographs, video images, video frames, thermal imaging, three-dimensional image, and/or any other type of image). Additionally, drones are equipped with sensors (e.g., positioning sensors) to identify the position and/or location (e.g., global positioning system coordinates) of the drone and/or communication sensors (e.g., Wi-Fi sensors, Bluetooth sensors, cellular communication sensors, etc.) to communicate with external devices. As used herein, autonomous flight includes autonomous control of the flight and/or movement of a vehicle using on-board controllers (e.g., without instructions from a remote device). As used herein, semi-autonomous flight includes instructions from a remote device that are executed by on-board controllers to execute the instructions, thereby combining user interaction with on-board automation. For example, an instruction to a drone may be to increase altitude to a first height and the on-board controllers may control the electrical and mechanical components of the drone to increase the altitude to the first height. As used herein, manual flight is user control of the electrical and/or mechanical components of the drone to control the flight pattern of the drone.

The images and/or audio captured by sensors may be stored in long term memory and/or storage and/or transmitted to a remote site for analysis and/or processing. In some examples, the image data and/or the audio data may be transmitted to a user via a user interface of a remote-control device. In such examples, the user can watch and/or listen to video/audio gathered by a drone.

The gathering of such images and/or audio by drones may raise privacy and/or security concerns in certain areas. For example, residents of an apartment building or house may not want a drone to gather images within a threshold range of the building. Accordingly, restricted (e.g., privacy and/or “no fly”) zones and/or geofences may be set up at different locations that prevent drones from navigating with the restricted zone. Restricted zones may be personal zones (e.g., an individual house or building) or area wide zones (e.g., a block of houses, an entire residential zone, an entire town, etc.). A user who manually navigates a drone through a restricted zone may be subject to fines and/or other criminal penalties.

Navigation through privacy and/or no fly zones is restricted. Accordingly, conventional drones navigate around such no fly zones. However, navigating around such restricted zones may substantially lengthen the distance to the destination, thereby consuming additional power resources and delaying the time for the drone to reach its destination. When a drone is used as a delivery mechanism, furthering the distance to the destination increases delivery cost/time. Examples disclosed herein allow the drone to navigate through such restricted zones by restricting and/or otherwise eliminating gathered or otherwise captured private data (e.g., image data, audio data, etc.) during flight through the restricted zone. In this manner, the drone can navigate using the shortest (e.g., optimal) path while maintaining the privacy of the restricted areas.

In some examples disclosed herein, a privacy controller determines when a drone is within a privacy zone and flags captured data as private data by enabling a privacy mode. The privacy mode ensures that private data collected by the drone while in the restricted zone is (A) never entered into long term memory and/or storage, (B) never transmitted to another device (e.g., a user interface, external server, database, etc.), and/or (C) deleted when no longer useful for navigation. For example, the short term memory architecture may be adjusted to allocate a bit of a register for flagging data that is collected in a privacy zone stored in the register.

In such an example, when the drone enters a private zone, the privacy controller enables a privacy mode to flag collected data in the short term by enabling a privacy bit in a cache architecture of the drone's memory. Alternatively, the example privacy controller may manipulate page table architecture to include a privacy indicator and/or use already allocated bits of the page table architecture to signify that the data is private (e.g., and not to be stored or transmitted).

In some examples (e.g., during manual and/or semi-autonomous operation of a drone), examples disclosed herein may prevent display of images and/or audio captured by the drone on a remote device (e.g., a remote control, computer, mobile phone, etc.). In such examples, the drone may pause navigation while the remote device alerts the user that the drone has entered into a restricted area where image and/or audio data is not available. Additionally, examples disclosed herein may provide options to the user as to how to proceed with navigation (e.g., return to a home base, enter into auto-pilot to navigate through the restricted zone without input from the user, return path until the drone is out of the restricted zone, etc.).

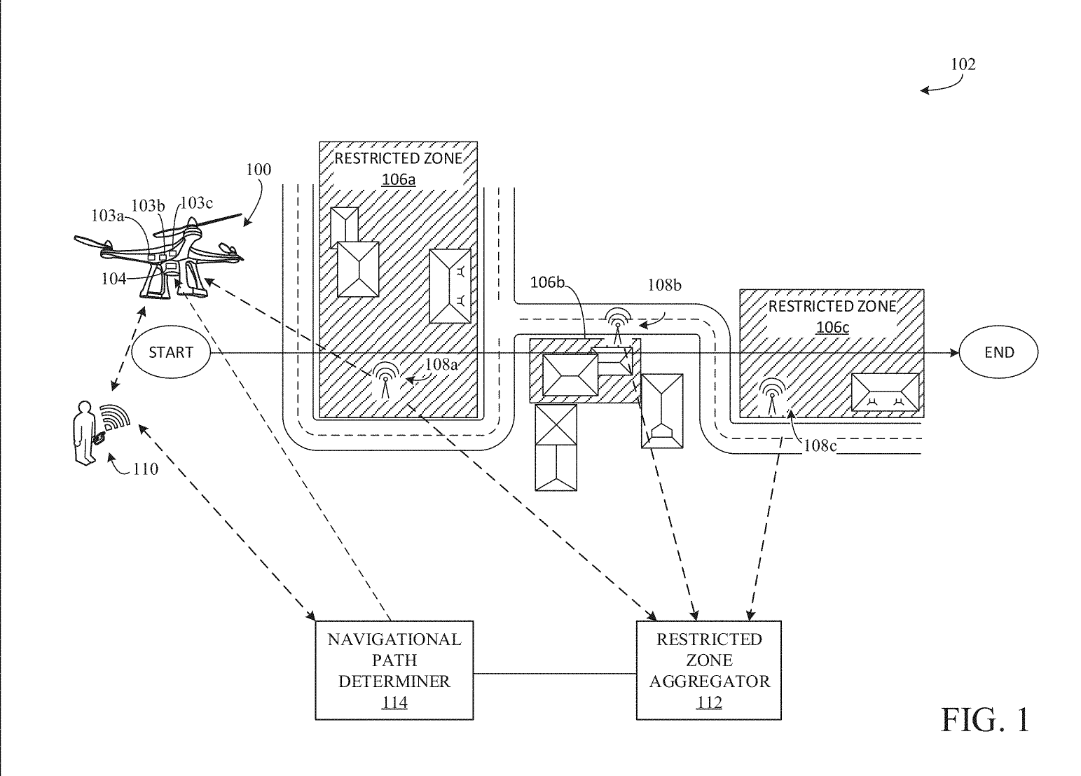

FIG. 1 illustrates an example drone 100 navigating through an example environment 102. The example environment 102 of FIG. 1 includes the example drone 100, example sensors 103a-c, an example privacy controller 104, example restricted zones 106a-c, example restricted zone identifiers 108a-c, an example remote device 110, an example restricted zone aggregator 112, and an example navigation path determiner 114.

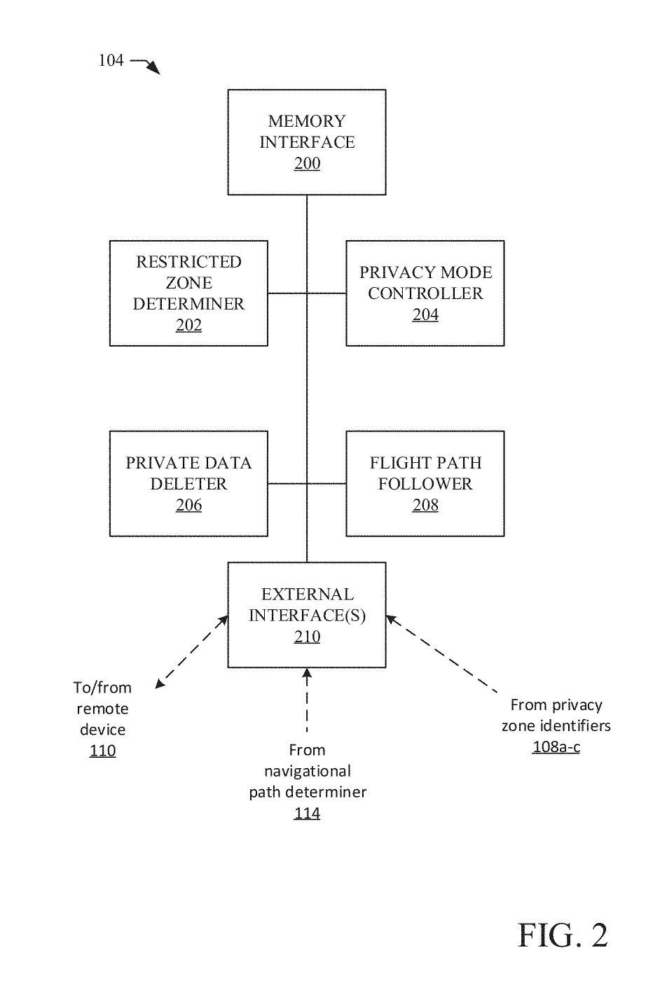

The example drone 100 of FIG. 1 is an unmanned aerial vehicle (UAV) that operates without a human pilot on board. The example drone 100 may be controlled to fly from a first location (e.g., start) to a second location (e.g., end). The example drone 100 may be controlled by instructions from a user (e.g., via the example remote device 110) and/or from the example navigational path determiner 114. Alternatively, as further described in conjunction with FIG. 2, the example drone 100 may be controlled autonomously via the example privacy controller 104 and/or any other on-board controller of the example drone 100. The example drone 100 includes the example sensor(s) 103a to gather (e.g., capture) image and/or audio data. The image and/or audio data may be used to help the example drone 100 navigate around obstacles (e.g., during autonomous and/or semi-autonomous control). Additionally, the image and/or sound data may be stored in memory and/or transmitted to the example remote device 110. In this manner, the user of the example remote device 110 can see and/or hear the images and/or sounds captured by the example drone 100. Additionally, drones are equipped with sensor(s) 103b (e.g., positioning sensors) to identify the position and/or location (e.g., global positioning system coordinates) of the drone and the example communication sensor(s) 103c to communicate with the example restricted zone identifiers 108a-c, the example remote device 110, and/or the example navigational path determiner 114. Although FIG. 1 is described in conjunction with the example drone 100, other unmanned vehicles (e.g., autonomous cars, boats, etc.) could alternatively be utilized in the example environment 102 using examples disclosed herein.

The example privacy controller 104 of the example drone 100 of FIG. 1 determines when the example drone 100 is within one of the example restricted zones 106a-c. When the example drone 100 is autonomously navigating, the example privacy controller 104 continues to gather image and/or audio data for navigational purposes; however, because the gathered data in restricted zones 106a-c is private or otherwise restricted data, the example privacy controller 104 prevents the gathered data from being stored into long term memory and/or storage and/or prevents the data from being transmitted to any other device (e.g., including the example remote device 110). Additionally, when the example drone 100 is being controlled by a user (e.g., via the example remote device 110), the example privacy controller 104 may alert the user (e.g., by transmitting instructions to the example remote device 110) that the drone 100 is entering and/or has entered the example restricted zone 106a and prevents the example drone 100 from sending collected data (e.g., image and/or audio data) to the example remote device 110. In some examples, the alert includes information asking how the user would like the example drone 100 to proceed.

The example restricted zones 106a-c of FIG. 1 are locations that are designated as privacy and/or no fly zones. The restricted zones 106a-c may be personal zones (e.g., an individual house or building, such as the example restricted zone 106b) or area wide zones (e.g., a block of houses, an entire residential zone, an entire town, etc., such as the example restricted zones 106a, 106c). The example restricted zones 106a-c include the example restricted zone identifiers 108a-c to identify the example restricted zones 106a-c. In some examples, the example restricted zone identifiers 108a-c provide location data related to the restricted zones 106a-c to the example restricted zone aggregator 112 and/or the example drone 100. Additionally or alternatively, the restricted zones 106a-c may be generated through geo-fencing software. In this manner, the example restricted zone aggregator 112 maintains the boundaries as defined by the generated geofence corresponding to the example restricted zones 106a-c. In some examples, the example restricted zone identifiers 108a-c may communicate with the example drone 100 to determine when the example drone 100 is in the example restricted zone 106a-c. In such examples, the example restricted zone identifiers 108a-c may communicate with residents and/or administrators of the example restricted zones 106a-c to alert the residents and/or administrators that the example drone 100 is within the example restricted zones 106a-c.

The example remote device 110 of FIG. 1 is a device that communicates with the example drone 100. In some examples, a user provides instructions to control the example drone via the example remote device 110. The example remote device 110 may be a computer, a processor, a mobile phone, a tablet, a remote control, and/or any other device capable of controlling the example drone 100. In such examples, the user may utilize the example remote device 110 to control the direction, speed, height, etc. of the example drone 100. Additionally or alternatively, the user may utilize the example remote device 110 to select a destination and the example drone 100 autonomously navigates to the destination. The example drone 100 transmits image and/or audio data to the example remote device 110. In this manner, the user can see and hear images and/or audio that the drone 100 is capturing in near real time. When the example remote device 110 instructs the example drone 100 to fly into/through one of the example restricted zones 106a-c, the example privacy controller 104 may transmit a warning and/or instructions to the example remote device 110 that the example drone 100 is in or nearing the example restricted zone 106a. In some examples, the remote device 110 is, includes, or is coupled to a storage unit (e.g., database). In this manner, data from the example drone 100 may be stored in the external storage to conserve the memory of the example drone 100. In some examples, the example remote device 110 may communicate with the example navigational path determiner 114. In such examples, the remote device 110 may provide a destination to the example navigational path determiner 114 and the example navigational path determiner 114 can generate a navigational path and transmit the navigational path to the example drone 100.

The example restricted zone aggregator 112 of FIG. 1 aggregates the data (e.g., location data, boundary data, etc.) related to the example restricted zones 106a-c. As described above, the example restricted zone aggregator 112 may receive the restricted zone data via the example restricted zone identifiers 108a-c and/or via geofencing software that identifies the example restricted zones 106a-c. The restricted zone aggregator 112 provides the aggregated restricted zone data to the example navigational path determiner 114.

The example navigational path determiner 114 of FIG. 1 receives the aggregated restricted zone data from the example restricted zone aggregator 112. The example navigational path determiner 114 is a remote device (e.g., station) that may transmit instructions (e.g., navigational paths) to the example drone 100 via a wireless network communication. In some examples, the navigational path determiner 114 generates a navigational path from a first location to a second location and transmits the navigational path to the example drone 100. In such examples, the privacy controller 104 transmits the restricted zone data so that the example drone 100 can enable privacy mode while in any one of the example restricted zones 106a-c. Alternatively, the example drone 100 may transmit its location to the example navigational path determiner 114 (e.g., while being controlled by the example remote device 110). In this manner, the example navigational path determiner 114 may send a response identifying whether the location of the example drone 100 is within the example restricted zones 106a-c or not. Additionally or alternatively, the example navigational path determiner 114 may communicate with the example remote device 110 to provide restricted zone data (e.g., location data identifying a location of the example restricted zones 106a-c). In this manner, when the drone 100 enables privacy mode and the example remote device 110 is no longer receiving image and/or audio data from the example drone 100, restricted zone data and/or other navigational data from the example navigational path determiner 114 may be transmitted to the example remote device 110 to provide navigational options.

FIG. 2 is a block diagram of the example privacy controller 104 of FIG. 1 disclosed herein, to navigate through the example restricted zones 106a-c of FIG. 1 while preserving privacy of the restricted zones 106a-c. While the example privacy controller 104 is described in conjunction with the example drone 100, the example privacy controller 104 may be utilized to navigate through any type of zone using any type of unmanned vehicle. The example privacy controller 104 includes an example memory interface 200, an example restricted zone determiner 202, an example privacy mode controller 204, an example private data deleter 206, an example flight path follower 208, and an example external interface(s) 210.

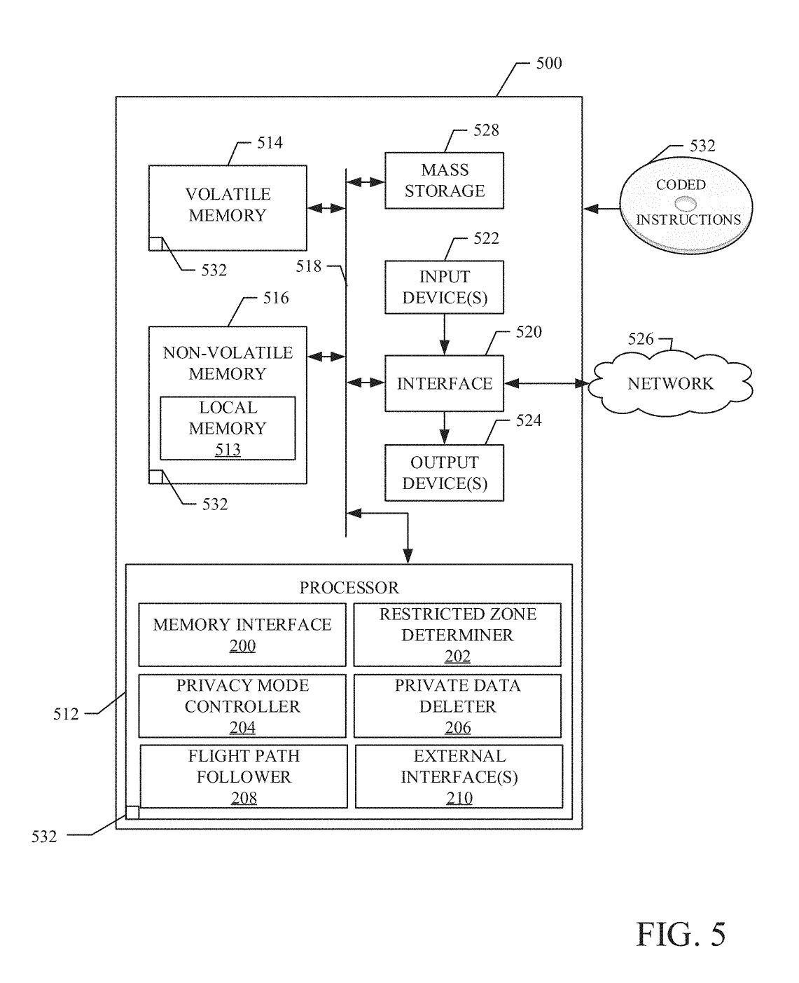

The example memory interface 200 of FIG. 2 interfaces with the short term memory (e.g., the example local memory 513 of FIG. 5). In some examples, the short term memory is a cache. Alternatively, the example short term memory may be any kind of volatile memory device. When the example drone 100 is in operation, the example sensor(s) 103a of the example drone 100 gathers image and/or audio data. In some examples, the example drone 100 uses the image and/or audio data to assistant the drone 100 to navigate around objects. Additionally or alternatively, the image and/or audio data is transmitted to the example remote device 110 for further processing. When the drone 100 is in and/or nearing the example restricted zone (s) 106a-c of FIG. 1, the example memory interface 200 communicates with the example short term memory to flag the gathered data. In this manner, flagged data can be used for navigational purposes and discarded without being stored into long term memory and/or storage and/or being transmitted to the remote device 110. In some examples, the memory interface 200 flags the data by adjusting one or more bit values of memory (e.g., registers) that store the collected data.

The example restricted zone determiner 202 determines whether the example drone 100 is within the example restricted zones 106a-c. In some examples, the drone 100 receives the restricted zones from the example navigational path determiner 114 (e.g., via the example external interface(s) 210). In such examples, the restricted zone determiner 202 may determine whether the example drone 100 is within the example restricted zone 106a by global positioning system (GPS) coordinates of the example drone 100 with location information from the example navigational path determiner 114. Alternatively, the drone position/location data may be determined based on other method of identifying location (e.g., Wi-Fi positioning system, cellular base station positioning system, radio broadcast positioning system, etc.). In some examples, the restricted zone determiner 202 determines whether it is within the example restricted zone 106a based on an intercepted signal from the example restricted zone identifier 108a. In such examples, when the example external interface(s) 210 receives a restricted signal from the example restricted zone identifier 108a, the example restriction zone determiner 202 determines that it is within the example restricted zone 106a. Alternatively, the restricted signal from the example restricted zone identifier 108a may include the GPS and/or other positioning data that identifies the boundaries of the example restricted zone 106a. In such an example, the restricted zone determiner 202 processes the received signal and determines the location of the example drone 100 through the example positioning sensor(s) 103b of the example drone 100 to determine whether or not the drone 100 is within the example restricted zone 106a.

The example privacy mode controller 204 of FIG. 2 enables and/or disables a privacy mode of the example drone 100. As described above, when privacy mode controller 204 enables the privacy mode, the example privacy mode controller 204 flags gathered data (e.g., video and/or audio data gathered within the restricted zone 106) as private data. In some examples (e.g., when the short term memory is a cache architecture), the example privacy mode controller 204 may flag the data as private data by modifying the cache architecture. In such examples, a privacy bit may be implemented in the registers associated with the private data. In this manner, the registers corresponding to private data is properly flagged by adjusting the logic value of the privacy bit (e.g., from ‘0’ to ‘1’ or vice versa).

In some examples (e.g., when the short term memory is a page table architecture), the example privacy mode controller 204 may flag the data by utilizing already allocated bit in a memory (e.g., a register). For example, the privacy mode controller 204 may utilize a caching disabled bit, a modified (e.g., dirty) bit, and/or a protection bit of the page frame architecture to flag the private data by adjusting the logic value(s) of the one or more bits. In this manner, the “writable” status of the table may be adjusted to prevent writing to long term memory and/or storage. In some examples, the privacy mode controller 204 may allocate parts of the short term memory for a first section of storage of private data (e.g., to be deleted and/or prevented from transmission) and a second section of storage for non-private data (e.g., data gathered outside the restricted zones 106a-c).

When the example drone 100 is outside of the example restricted zone 106a, the example privacy mode controller 204 disables privacy mode to disable the flagging of gathered data as private data. In this manner, the example drone 100 returns to normal operation.

The example private data deleter 206 of FIG. 2 deletes any locally stored private data from short term memory via the example memory interface 200. In some examples, the private data deleter 206 deletes the private data at set time intervals while the drone is within the example restricted zone 106a. Additionally or alternatively, the example private data deleter 206 deletes the private data after the example restricted zone determiner 202 determines that the example drone 100 is outside the example restricted zone 106a.

The example flight path follower 208 of FIG. 2 navigates the example drone 100 according to the navigational path (e.g., via the example navigational path determiner 114 and/or the instructions from a user of the example remote device 110). The example path follower 208 navigates the example drone 100 by interfacing (e.g., communicating) with the mechanical and/or electrical components of the example drone 100 to control the flight (e.g., direction, speed, height, etc.) of the example drone 100.

The example external interface(s) 210 interface (e.g., using a wireless network communication) with the example restricted zone identifier 108a, the example navigational path determiner 114, and/or the example remote device 110 of FIG. 1. The wireless network communication may be communicated via a local area network, a wide area network, the Internet, a cloud, or any other type of communications network using the example communication sensor 103c (e.g., Wi-Fi sensor, Bluetooth sensor, cellular network sensor and/or any other type of communication sensor). In some examples, the external interface 210 is a single interface communicating with the external devices/servers. In some examples, the external interface 210 includes more than one interface to communicate with the external devices/servers. The example external interface(s) 210 transmits received data to the example memory interface 200, the example restricted zone determiner 202, the example privacy mode controller 204, the example private data deleter 206, and/or the example flight path follower 208 for further processing. In some examples, when the example privacy mode controller 204 has enabled privacy mode, the example external interface(s) 210 restrict communication of flagged data (e.g., private data) to an external device/server (e.g., the example remote device 110).

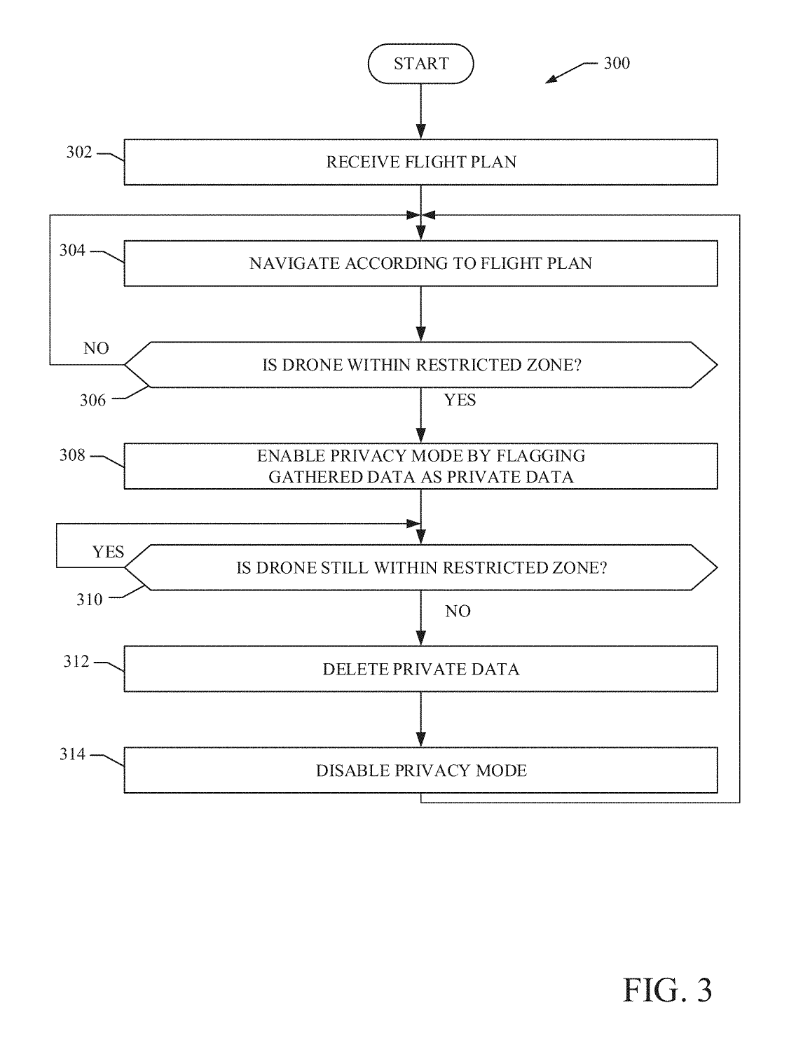

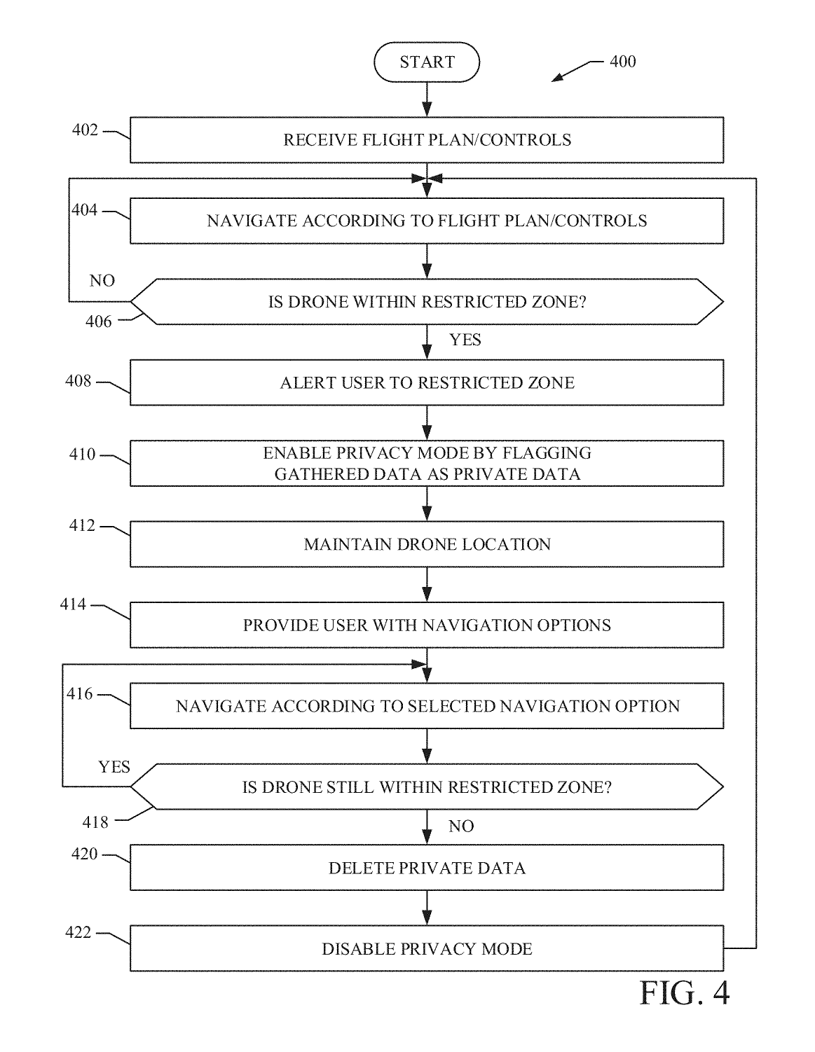

While example manners of implementing the example privacy controller 104 of FIG. 1 are illustrated in conjunction with FIG. 2, elements, processes and/or devices illustrated in conjunction with FIG. 2 may be combined, divided, re-arranged, omitted, eliminated and/or implemented in any other way. Further, the example memory interface 200, the example restricted zone determiner 202, the example privacy mode controller 204, the example private data deleter 206, the example flight path follower 208, the example external interface(s) 210, and/or, more generally, the example privacy controller 104 of FIG. 2 may be implemented by hardware, machine readable instructions, software, firmware and/or any combination of hardware, machine readable instructions, software and/or firmware. Thus, for example, any of the example memory interface 200, the example restricted zone determiner 202, the example privacy mode controller 204, the example private data deleter 206, the example flight path follower 208, the example external interface(s) 210, and/or, more generally, the example privacy controller 104 of FIG. 2 could be implemented by analog and/or digital circuit(s), logic circuit(s), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example memory interface 200, the example restricted zone determiner 202, the example privacy mode controller 204, the example private data deleter 206, the example flight path follower 208, the example external interface(s) 210, and/or, more generally, the example privacy controller 104 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example privacy controller 104 of FIG. 2 include elements, processes and/or devices in addition to, or instead of, those illustrated in conjunction with FIGS. 3-4, and/or may include more than one of any or all of the illustrated elements, processes and devices.

Flowcharts representative of example machine readable instructions for implementing the example privacy controller 104 of FIG. 2 is shown in conjunction with FIGS. 3-4. In the examples, the machine readable instructions comprise a program for execution by a processor such as the processor 512 shown in the example processor platform 500 discussed below in connection with FIG. 5. The program may be embodied in machine readable instructions stored on a tangible computer readable storage medium such as a CD-ROM, a floppy disk, a hard drive, a digital versatile disk (DVD), a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowcharts illustrated in conjunction with FIGS. 3-4, many other methods of implementing the example privacy controller 104 of FIG. 2 may alternatively be used. For example, the order of execution of the blocks may be changed, and/or some of the blocks described may be changed, eliminated, or combined. Although the flowcharts of FIGS. 3-4 depict example operations in an illustrated order, these operations are not exhaustive and are not limited to the illustrated order. In addition, various changes and modifications may be made by one skilled in the art within the spirit and scope of the disclosure. For example, blocks illustrated in the flowchart(s) may be performed in an alternative order or may be performed in parallel.

As mentioned above, the example processes of FIGS. 3-4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 3-4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. In addition, the term “including” is open-ended in the same manner as the term “comprising” is open-ended.

FIG. 3 is an example flowchart 300 representative of example machine readable instructions that may be executed to implement the example privacy controller 104 of FIG. 2 to preserve privacy from the example drone 100 of FIG. 1 during autonomous flight. Although, the flowchart 300 of FIG. 3 is described in conjunction with the example drone 100 in the example environment 102 of FIG. 1, the process may be implemented using any type of unmanned vehicle in any environment.

At block 302, the example external interface(s) 210 receives a flight plan from the example navigational path determiner 114 and/or the example remote device 110 of FIG. 1. The flight plan of the example flowchart 300 is a fully autonomous flight path where the example navigational path determiner 114 and/or the example remote device 110 selects a destination and the example drone 100 autonomously navigates to the destination following the defined path. In some examples, the flight path may include restricted zone location data identifying the example restricted zones 106a-c of FIG. 1. At block 304, the example flight path follower 208 navigates according to the flight path. As described above, the example flight path follower 208 interfaces with the electrical and/or mechanical components that control the drone 100 during flight.

At block 306, the example restricted zone determiner 202 determines if the example drone 100 is within the example restricted zone 106a. The example restricted zone determiner 202 gathers drone positioning data from the example sensor 103a of the example drone 100 to determine the location of the example drone 100. The example restricted zone determiner 202 determines if the example drone 100 is within the example restricted zone 106a based on a comparison of the drone positioning data and the restricted zone location data. In some examples, the example restricted zone determiner 202 may transmit the drone location data to the example navigational path determiner 114 and determine if it is within the restricted zone 106a based on the response from the navigational path determiner 114, as described above in conjunction with FIG. 1. Alternatively, the example restricted zone determiner 202 may determine that the current location of the example drone 100 is within the example restricted zone 106a based on receiving a restricted zone signal (e.g., via the example external interface(s) 210) from the example restricted zone identifier 108a of the example restricted zone 106a.

If the example restricted zone determiner 202 determines that the example drone 100 is not within the example restricted zone 106a, the example restricted zone determiner 202 continues to monitor the drone's 100 position during flight to determine when the example drone 100 is within the example restricted zone 106a. If the example restricted zone determiner 202 determines that the example drone 100 is within the example restricted zone 106a, the example privacy mode controller 204 enables privacy mode by flagging gathered (e.g., collected) data (e.g., image and/or audio data) as private data (block 308). As described above in conjunction with FIG. 2, the example privacy mode controller 204 may flag the example gathered data by changing (e.g., via the example memory interface 200) the values stored in an allocated bit(s) of a register in short term memory. Flagging the gathered data as private prevents the private data from being stored in long term memory and/or being transmitted to any other device (e.g., the example remote device 110). In this manner, the example drone 100 can continue to use private image and/or audio data for autonomous navigational purposes while preserving privacy of people and/or things within the example restricted zone 106a.

At block 310, the example restricted zone determiner 202 determines if the example drone 100 is still within the example restricted zone 106a. If the example restricted zone determiner 202 determines that the example drone 100 is still within the example restricted zone 106a, the example restricted zone determiner 202 continues to monitor the example drone's 100 position as it navigates through the example restricted zone 106a. If the example restricted zone determiner 202 determines that the example drone 100 is not still within the example restricted zone 106a, the example private data deleter 206 deletes or otherwise flushes the flagged private data (e.g., block 312). As described above in conjunction with FIG. 2, the example private data deleter 206 may additionally delete flagged private data that is no longer being used by the example drone 100 to navigate while the drone is within the example restricted zone 106a. At block 314, the example privacy mode controller 204 disables the privacy mode (e.g., via the example memory interface 200) by ceasing the flagging of gathered data as private data and continues to navigate according to the flight plan.

FIG. 4 is an example flowchart 400 representative of example machine readable instructions that may be executed to implement the example privacy controller 104 of FIG. 2 to preserve privacy from the example drone 100 of FIG. 1 during manually or semi-autonomous flight. Although, the flowchart 400 of FIG. 4 is described in conjunction with the example drone 100 in the example environment 102 of FIG. 1, the process may be implemented using any type of unmanned vehicle in any environment.

At block 402, the example external interface(s) 210 receives a flight plan/controls from the example remote device 110 of FIG. 1. The flight plan of the example flowchart 400 is a manually or semi-autonomous flight path where the example remote device 110 controls flight of the example drone 100. At block 404, the example flight path follower 208 navigates according to the flight path/controls from the example remote device 110. As described above, the example flight path follower 208 interfaces with the electrical and/or mechanical components that control the drone 100 during flight.

At block 406, the example restricted zone determiner 202 determines if the example drone 100 is within the example restricted zone 106a. The example restricted zone determiner 202 gathers drone positioning data from the example positioning sensor 103b of the example drone 100 to determine the location of the example drone 100. The example restricted zone determiner 202 determines if the example drone 100 is within the example restricted zone 106a based on a comparison of the drone positioning data and the restricted zone location data. In some examples, the example restricted zone determiner 202 may transmit the drone location data to the example navigational path determiner 114 and determine if it is within the restricted zone 106a based on the response from the navigational path determiner 114, as described above in conjunction with FIG. 1. Alternatively, the example restricted zone determiner 202 may determine that the current location of the example drone 100 is within the example restricted zone 106a based on receiving a restricted zone signal (e.g., via the example external interface(s) 210) from the example restricted zone identifier 108a of the example restricted zone 106a.

If the example restricted zone determiner 202 determines that the example drone 100 is not within the example restricted zone 106a, the example restricted zone determiner 202 continues to monitor the drone's 100 position during flight to determine when the example drone 100 is within the example restricted zone 106a. If the example restricted zone determiner 202 determines that the example drone 100 is within the example restricted zone 106a, the example privacy mode controller 204 alters the user of the example remote device 110 that the example drone is within the example restricted zone 106a (block 408). In some examples, the privacy mode controller 204 sends a restriction signal to the example remote device 110 via the example external interface(s) 210 to alert the user to the restricted zone 106a. At block 410, the example privacy mode controller 204 enables privacy mode by flagging gathered (e.g., collected) data (e.g., image and/or audio data) as private data. As described above in conjunction with FIG. 2, the example privacy mode controller 204 may flag the example gathered data by changing (e.g., via the example memory interface 200) the values stored in an allocated bit(s) of a register in short term memory. Flagging the gathered data as private prevents the private data from being stored in long term memory and/or being transmitted to the example remote device 110, thereby preventing the user of the example remote device 110 from being exposed to the flagged private data. In this manner, the example drone 100 can continue to use private image and/or audio data for autonomous navigational purposes while preserving privacy of people and/or things within the example restricted zone 106a.

At block 412, the example flight path follower 208 maintains the drone location, thereby pausing navigation of the example drone 100 to allow the user to determine how the example drone 100 should proceed given the example restricted zone 106a. At block 414, the example privacy mode controller 204 provides the user of the example remote device 110 with navigation options via the example external interface(s) 210. In some examples, the navigation options include autonomously navigating through the example restricted zone 106a until the drone is outside the restricted zone 106a, reversing navigation direction until the example drone 100 is outside the example restricted zone 106a, returning to a home position, etc. At block 416, the example flight path follower 208 navigates the example drone 100 according to the selected navigation option.

At block 418, the example restricted zone determiner 202 determines if the example drone 100 is still within the example restricted zone 106a. If the example restricted zone determiner 202 determines that the example drone 100 is still within the example restricted zone 106a, the example restricted zone determiner 202 continues to monitor the example drone's 100 position as it navigates through the example restricted zone 106a. If the example restricted zone determiner 202 determines that the example drone 100 is not still within the example restricted zone 106a, the example private data deleter 206 deletes or otherwise flushes the flagged private data (e.g., block 420). As described above in conjunction with FIG. 2, the example private data deleter 206 may additionally delete flagged private data that is no longer being used by the example drone 100 to navigate while the drone is within the example restricted zone 106a. At block 422, the example privacy mode controller 204 disables the privacy mode (e.g., via the example memory interface 200) by ceasing the flagging of gathered data as private data and continues to navigate according to the flight plan/user controls.

FIG. 5 is a block diagram of an example processor platform 500 capable of executing the instructions of FIGS. 3 and 4 to implement the example privacy controller 104 of FIG. 2. The processor platform 500 can be, for example, a server, a personal computer, a mobile device (e.g., a cell phone, a smart phone, a tablet such as an iPad™), a personal digital assistant (PDA), an Internet appliance, or any other type of computing device.

The processor platform 500 of the illustrated example includes a processor 512. The processor 512 of the illustrated example is hardware. For example, the processor 512 can be implemented by integrated circuits, logic circuits, microprocessors or controllers from any desired family or manufacturer.

The processor 512 of the illustrated example includes the example memory 513 (e.g., a cache). The example processor 512 of FIG. 5 executes the instructions of FIGS. 3 and 4 to implement the example memory interface 200, the example restricted zone determiner 202, the example privacy mode controller 204, the example private data deleter 206, the example flight path follower 208, and/or the example external interface(s) 210 to implement the example privacy controller 104 (FIG. 1). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives.

The coded instructions 532 of FIGS. 3 and 4 may be stored in the mass storage device 528, in the volatile memory 514, in the non-volatile memory 516, and/or on a removable tangible computer readable storage medium such as a CD or DVD.

Example 1 is drone to preserve privacy. Example 1 includes, when the drone is within a restricted zone, flagging, by executing an instruction with a processor of the drone, data gathered by the drone in the restricted zone. Example 1 also includes, when the drone exits the restricted zone, deleting, by executing an instruction with the processor of the drone, the flagged data.

Example 2 includes the subject matter of example 1, further including short term memory to store the flagged data of the drone, the privacy mode controller to flag the gathered data to prevent the gathered data from being stored in long term memory.

Example 3 includes the subject matter of example 2, wherein the privacy mode controller is to flag the gathered data by changing one or more bit values of a register of the short term memory, the register corresponding to the gathered data.

Example 4 includes the subject matter of example 1, wherein the privacy mode controller is to flag the gathered data to prevent the gathered data from being transmitted to an external device.

Example 5 includes the subject matter of example 4, further including an interface to transmit a restriction signal to a remote device identifying that the drone is within the restricted zone.

Example 6 includes the subject matter of example 1, wherein the gathered data includes at least one of an image or audio gathered by the drone.

Example 7 includes the subject matter of example 6, wherein the image includes at least one of a photograph, a three-dimensional image, or a video frame.

Example 8 includes the subject matter of example 7, wherein the drone is to use the at least one of the image or the audio to navigate around objects.

Example 9 includes the subject matter of examples 1-8, further including a restricted zone determiner to determine that the drone is within the restricted zone based on at least one of restricted zone location data transmitted to the drone from a server or restricted zone location data transmitted to the drone from the restricted zone.

Example 10 includes the subject matter of examples 1-8, wherein the private data deleter is to delete the flagged data while the drone is within the restricted zone.

Example 11 includes the subject matter of examples 1-8, further including one or more interfaces to, when the drone enters the restricted zone, transmit an alert to at least one of a remote device identifying that the drone has entered the restricted zone or an administrator of the restricted zone.

Example 12 includes the subject matter of example 11, further including a flight path follower to, when the drone enters the restricted zone, cease movement of the drone.

Example 13 includes the subject matter of example 12, wherein the one or more interfaces is to, when the drone ceases, provide navigation options to the remote device.

Example 14 includes the subject matter of examples 1-8, wherein the privacy mode controller is to, when the drone exits the restricted zone, prevent the flagging of the gathered data.

Example 15 is a method to preserve privacy from a drone, the method comprising when the drone is within a restricted zone, flagging, by executing an instruction with a processor of the drone, data gathered by the drone in the restricted zone. Example 15 also includes when the drone exits the restricted zone, deleting, by executing an instruction with the processor of the drone, the flagged data.

Example 16 includes the subject matter of example 15, wherein the flagged data is stored in short term memory of the drone, the flagging of the gathered data preventing the gathered data from being stored in long term memory.

Example 17 includes the subject matter of example 16, wherein the flagging of the gathered data includes changing one or more bit values of a register of the short term memory, the register corresponding to the gathered data.

Example 18 includes the subject matter of example 16, wherein flagging the gathered data prevents the gathered data from being transmitted to an external device.

Example 19 includes the subject matter of example 18, further including transmitting a restriction signal to a remote device identifying that the drone is within the restricted zone.

Example 20 includes the subject matter of example 15, wherein the gathered data includes at least one of an image or audio gathered by the drone.

Example 21 includes the subject matter of example 20, wherein the drone uses the at least one of the image or the audio to navigate around objects.

Example 22 includes the subject matter of examples 15-21, further including determining that the drone is within the restricted zone based on at least one of restricted zone location data transmitted to the drone from a server or restricted zone location data transmitted to the drone from the restricted zone.

Example 23 includes the subject matter of examples 15-21, further including deleting the flagged data while the drone is within the restricted zone.

Example 24 includes the subject matter of examples 15-21, further including, when the drone enters the restricted zone, transmitting an alert to a remote device identifying that the drone has entered the restricted zone.

Example 25 includes the subject matter of example 24, further including, when the drone enters the restricted zone, ceasing movement of the drone.

Example 26 includes the subject matter of example 25, further including, when the drone ceases, providing navigation options to the remote device.

Example 27 includes the subject matter of examples 15-21, further including, when the drone exits the restricted zone, preventing the flagging of the gathered data.

Example 28 is a tangible computer readable storage medium comprising instructions which, when executed, cause a drone to at least, when a drone is within a restricted zone, flag data gathered by the drone in the restricted zone. Example 28 also includes, when the drone exits the restricted zone, delete the flagged data.

Example 29 includes the subject matter of example 28, wherein the instructions cause the drone to store the flagged data of the drone, the flagging of the gathered data to prevent the gathered data from being stored in long term memory.

Example 30 includes the subject matter of example 29, wherein the instructions cause the drone to flag the gathered data by changing one or more bit values of a register of the short term memory, the register corresponding to the gathered data.

Example 31 includes the subject matter of example 28, wherein the instructions cause the drone to flag the gathered data to prevent the gathered data from being transmitted to an external device.

Example 32 includes the subject matter of example 31, wherein the instructions cause the drone to transmit a restriction signal to a remote device identifying that the drone is within the restricted zone.

Example 33 includes the subject matter of example 28, wherein the gathered data includes at least one of an image or audio gathered by the drone.

Example 34 includes the subject matter of example 33, wherein the image includes at least one of a photograph, a three-dimensional image, or a video frame.

Example 35 includes the subject matter of example 34, wherein the instructions cause the drone to use the at least one of the image or the audio to navigate around objects.

Example 36 includes the subject matter of examples 28-25, wherein the instructions cause the drone to determine that the drone is within the restricted zone based on at least one of restricted zone location data transmitted to the drone from a server or restricted zone location data transmitted to the drone from the restricted zone.

Example 37 includes the subject matter of examples 28-35, wherein the instructions cause the drone to delete the flagged data while the drone is within the restricted zone.

Example 38 includes the subject matter of examples 28-35, wherein the instructions cause the drone to, when the drone enters the restricted zone, transmit an alert to at least one of a remote device identifying that the drone has entered the restricted zone or an administrator of the restricted zone.

Example 39 includes the subject matter of example 38, wherein the instructions cause the drone to, when the drone enters the restricted zone, cease movement of the drone.

Example 40 includes the subject matter of example 39, wherein the instructions cause the drone to, when the drone ceases, provide navigation options to the remote device.

Example 41 includes the subject matter of examples 28-35, wherein the instructions cause the drone to, when the drone exits the restricted zone, prevent the flagging of the gathered data.

Example 42 is an apparatus comprising a first means for, when a drone is within a restricted zone, flagging data gathered by the drone in the restricted zone. Example 42 also includes a second means for, when the drone exits the restricted zone, deleting the flagged data.

Example 43 includes the subject matter of example 42, further including a third means for storing the flagged data of the drone, the first means for flagging the gathered data to prevent the gathered data from being stored in long term memory.

Example 44 includes the subject matter of example 43, wherein the first means is for flagging the gathered data by changing one or more bit values of a register of the third means, the register corresponding to the gathered data.

Example 45 includes the subject matter of example 42, wherein the first means is for flagging the gathered data to prevent the gathered data from being transmitted to an external device.

Example 46 includes the subject matter of example 45, further including a fourth means for transmitting a restriction signal to a remote device identifying that the drone is within the restricted zone.

Example 47 includes the subject matter of example 42, wherein the gathered data includes at least one of an image or audio gathered by the drone.

Example 48 includes the subject matter of example 47, wherein the image includes at least one of a photograph, a three-dimensional image, or a video frame.

Example 49 includes the subject matter of example 48, wherein the drone is to use the at least one of the image or the audio to navigate around objects.

Example 50 includes the subject matter of examples 42-49, further including a fifth means for determining that the drone is within the restricted zone based on at least one of restricted zone location data transmitted to the drone from a server or restricted zone location data transmitted to the drone from the restricted zone.

Example 51 includes the subject matter of examples 42-49, wherein the second means is for deleting the flagged data while the drone is within the restricted zone.

Example 52 includes the subject matter of examples 42-49, further including a fourth means for, when the drone enters the restricted zone, transmitting an alert to at least one of a remote device identifying that the drone has entered the restricted zone or an administrator of the restricted zone.

Example 53 includes the subject matter of example 52, further including a sixth means for, when the drone enters the restricted zone, ceasing movement of the drone.

Example 54 includes the subject matter of example 53, wherein the fourth means is for, when the drone ceases, providing navigation options to the remote device.

Example 55 includes the subject matter of examples 42-49, wherein the first means is for, when the drone exits the restricted zone, preventing the flagging of the gathered data.

From the foregoing, it will be appreciated that the above disclosed methods, apparatus, and articles of manufacture may be used to preserve privacy from a drone during navigation of the drone. Conventional techniques of navigating drones follow navigational (e.g., flight) paths that avoid restricted flight zones to avoid collecting image and/or audio data from the restricted flight zones. However, such conventional techniques require more complicated, more expensive, and longer flight paths that waste drone resources. Examples disclosed herein alleviate such problems by enabling a privacy mode when the drone is within a restricted zone. In this manner, the drone is able to fly through restricted zones without comprising the privacy of the restricted zone. The example privacy mode disclosed herein includes flagging data collect by the drone within the restricted zone. In this manner, the drone can utilize the flagged private data to help avoid collision with objects and prevent the flagged private data from being stored in long term memory and/or transmitted to any other device. Examples disclosed herein allow drones to navigate through restricted zones (e.g., according to an optimal navigational path) without worry about compromising the privacy of the restricted zone.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A drone comprising:
a privacy mode controller to, when the drone is within a restricted zone, flag data gathered by the drone in the restricted zone; and
a private data deleter to, when the drone exits the restricted zone, delete the flagged data.

2. The drone of claim 1, further including short term memory to store the flagged data of the drone, the privacy mode controller to flag the gathered data to prevent the gathered data from being stored in long term memory.

3. The drone of claim 2, wherein the privacy mode controller is to flag the gathered data by changing one or more bit values of a register of the short term memory, the register corresponding to the gathered data.

4. The drone of claim 1, wherein the privacy mode controller is to flag the gathered data to prevent the gathered data from being transmitted to an external device.

5. The drone of claim 4, further including an interface to transmit a restriction signal to a remote device identifying that the drone is within the restricted zone.

6. The drone of claim 1, wherein the gathered data includes at least one of an image or audio gathered by the drone.

7. The drone of claim 6, wherein the image includes at least one of a photograph, a three-dimensional image, or a video frame.

8. The drone of claim 7, wherein the drone is to use the at least one of the image or the audio to navigate around objects.

9. The drone of claim 1, further including a restricted zone determiner to determine that the drone is within the restricted zone based on at least one of restricted zone location data transmitted to the drone from a server or restricted zone location data transmitted to the drone from the restricted zone.

10. The drone of claim 1, wherein the private data deleter is to delete the flagged data while the drone is within the restricted zone.

11. The drone of claim 1, further including one or more interfaces to, when the drone enters the restricted zone, transmit an alert to at least one of a remote device identifying that the drone has entered the restricted zone or an administrator of the restricted zone.

12. The drone of claim 11, further including a flight path follower to, when the drone enters the restricted zone, cease movement of the drone.

13. The drone of claim 12, wherein the one or more interfaces is to, when the drone ceases, provide navigation options to the remote device.

14. The drone of claim 1, wherein the privacy mode controller is to, when the drone exits the restricted zone, prevent the flagging of the gathered data.

15. A method to preserve privacy from a drone, the method comprising:
when the drone is within a restricted zone, flagging, by executing an instruction with a processor of the drone, data gathered by the drone in the restricted zone; and
when the drone exits the restricted zone, deleting, by executing an instruction with the processor of the drone, the flagged data.

16. The method of claim 15, wherein the flagged data is stored in short term memory of the drone, the flagging of the gathered data preventing the gathered data from being stored in long term memory.

17. The method of claim 16, wherein the flagging of the gathered data includes changing one or more bit values of a register of the short term memory, the register corresponding to the gathered data.

18. The method of claim 16, wherein flagging the gathered data prevents the gathered data from being transmitted to an external device.

19. A tangible computer readable storage medium comprising instructions which, when executed, cause a drone to at least:
when a drone is within a restricted zone, flag data gathered by the drone in the restricted zone; and
when the drone exits the restricted zone, delete the flagged data.

20. The computer readable medium of claim 19, wherein the instructions cause the drone to store the flagged data of the drone, the flagging of the gathered data to prevent the gathered data from being stored in long term memory.
